(19) United States
(12) Patent Application Publication
(10) Pub. No.: US 2024/0216724 A1
(43) Pub. Date: Jul. 4, 2024

(54) FIRE PROTECTION APPARATUS AND FIRE PROTECTION METHOD

(71) Applicant: SEMES CO., LTD., Cheonan-si (KR)

(72) Inventors: Eunsang YOON, Cheonan-si (KR); Chul Jun PARK, Cheonan-si (KR); Min Beom KIM, Cheonan-si (KR); Seungkeun JUN, Cheonan-si (KR)

(73) Assignee: SEMES CO., LTD., Cheonan-si (KR)

(21) Appl. No.: 18/395,489

(22) Filed: Dec. 23, 2023

(30) Foreign Application Priority Data
Dec. 29, 2022 (KR) 10-2022-0188948

(51) Int. Cl. A62C 2/22; A62C 2/24

(52) U.S. Cl. CPC A62C 2/22; A62C 2/24

(57) ABSTRACT

Provided is a fire protection apparatus and fire protection method capable of improving sealability of a sub-shutter device, the fire protection apparatus including a door frame mounted in a vertical passage between an upper floor and a lower floor of a building or in a horizontal passage between a first compartment and a second compartment of the building, a guide rail provided at a side of the door frame to guide a lift to pass through the vertical passage or to guide a carriage to pass through the horizontal passage, a main shutter device mounted on the door frame to open or close a main passage space between the door frame and the guide rail, and a sub-shutter device mounted on the main shutter device to close an internal space of the guide rail in association with the main shutter device when the main shutter device is closed.

### CROSS-REFERENCE TO RELATED PATENT APPLICATION

This application claims the benefit of Korean Patent Application No. 10-2022-0188948, filed on Dec. 29, 2022, in the Korean Intellectual Property Office, the disclosure of which is herein incorporated by reference in its entirety.

### BACKGROUND OF THE INVENTION

### 1. Field of the Invention

The present invention relates to a fire protection apparatus and fire protection method and, more particularly, to a fire protection apparatus and fire protection method capable of improving sealability of a sub-shutter device.

### 2. Description of the Related Art

In general, the production line of semiconductor or display manufacturing plants may consist of multiple floors of cleanrooms and equipments for performing processes such as deposition, exposure, etching, ion implantation, and cleaning may be installed on each floor. Semiconductor devices or display devices may be manufactured by repeatedly performing a series of unit processes on semiconductor wafers used as semiconductor wafers or glass substrates used as display boards.

Meanwhile, materials, i.e., the semiconductor wafers or the glass substrates, may be transferred between the floors by using a tower lift mounted in a vertical direction through the floors. Each floor may be provided with a lift passage for the tower lift, and the lift passage may include a fire shutter for blocking flames, smoke, etc. in case of fire.

The fire shutter may be mounted in a vertical passage between an upper floor and a lower floor of a building or in a horizontal passage between a first compartment and a second compartment of the building.

However, according to an existing fire shutter including a main shutter for opening or closing a main passage and a sub-shutter for opening or closing an internal space of a guide rail, when a linear motor is mounted in the guide rail, the sub-shutter may not be easily accurately positioned between rails or stators of the linear motor and thus sealability of the sub-shutter may be reduced.

In addition, according to the existing fire shutter, because a main shutter driver for driving the main shutter and a sub-shutter driver for driving the sub-shutter are mounted independently and separately, product costs may be high, the structure may be complicated, and apparatus operation and management may be inconvenient.

### SUMMARY OF THE INVENTION

The present invention provides a fire protection apparatus and fire protection method capable of greatly improving sealability of a sub-shutter device by accurately positioning the sub-shutter device between rails or stators of a linear motor by using a position adjusting device when the linear motor is mounted in a guide rail, of achieving structural simplification and product cost reduction by associating a main shutter device with the sub-shutter device, and of facilitating apparatus operation and management. However, the above description is merely an example, and the scope of the present invention is not limited thereto.

According to an aspect of the present invention, there is provided a fire protection apparatus including a door frame mounted in a vertical passage between an upper floor and a lower floor of a building or in a horizontal passage between a first compartment and a second compartment of the building, a guide rail provided at a side of the door frame to guide a lift to pass through the vertical passage or to guide a carriage to pass through the horizontal passage, a main shutter device mounted on the door frame to open or close a main passage space between the door frame and the guide rail, a sub-shutter device mounted on the main shutter device to close an internal space of the guide rail in association with the main shutter device when the main shutter device is closed, and a position adjusting device mounted between an installation surface of the building and the door frame to improve sealability of the sub-shutter device, and adjusting a position of the door frame.

The position adjusting device may include a base mounted on the installation surface of the building, a screw rod mounted on the base, and a nut member screw-coupled to the screw rod to move forward or backward so as to support the door frame.

The guide rail may be provided, at a side, with a hollow part through which the sub-shutter device passes and which has a sufficient height greater than a maximum height of the sub-shutter device adjustable by the position adjusting device.

The sub-shutter device may include a housing fixed to the main shutter device and having a storage space, a push bar protruding from the housing and mounted on the housing to slide in a first direction, an expandable wing mounted in the storage space of the housing to slide in a second direction so as to be stretched out or retracted in, and a power transmitter for converting first-direction motion into second-direction motion to stretch out the expandable wing in the second direction when the push bar is pressed in the first direction.

The power transmitter may include an inclined link having an end hinge-coupled to a bar hinge shaft provided at a side of the push bar, and another end hinge-coupled to a wing hinge shaft provided at a rear end of the expandable wing and penetrating through a guide hole formed in the housing along the second direction.

The inclined link may be inclined at a first angle with respect to the first direction when the expandable wing is retracted in, or inclined at a second angle, which is greater than the first angle, with respect to the first direction when the expandable wing is stretched out.

The inclined link may include two links, which cross each other in an X shape overall, to simultaneously stretch out a side expandable wing and another side expandable wing.

The push bar connected to the two links may be provided in a U shape overall.

The sub-shutter device may further include an elastic spring for applying elastic restoring force in a forward direction of the push bar.

The housing may be provided in a shape corresponding to the hollow part formed in the guide rail such that at least a portion of the housing penetrates through the hollow part to stretch out the expandable wing.

The main shutter device may include a first main shutter mounted at a side of a main shutter guide member mounted on the door frame, and moved along the main shutter guide member, a second main shutter mounted at another side of the main shutter guide member mounted on the door frame, and moved along the main shutter guide member, and a shutter driver for driving the first and second main shutters toward or away from each other by using a single motor.

Conveyor belt protection slits may be formed at front ends of the first and second main shutters to protect conveyor belts.

The sub-shutter device may include a first sub-shutter mounted at a front end of the first main shutter, and a second sub-shutter mounted at a front end of the second main shutter to correspond to the first sub-shutter.

Push bars of the first and second sub-shutters may be mounted at corresponding positions and pressed in contact with each other to stretch out expandable wings of the first and second sub-shutters in association with the first and second main shutters when the first and second main shutters are closed.

Conveyor belt protection slits may be formed at front ends of the first and second sub-shutters to protect conveyor belts.

The guide rail may include a first rail for guiding a side of the lift or the carriage, and a second rail for guiding another side of the lift or the carriage.

The first or second rail may be provided, at a side, with a hollow part through which at least a portion of the sub-shutter device passes.

According to another aspect of the present invention, there is provided a fire protection method including (a) adjusting a gap between a door frame and an installation surface of a building by using a position adjusting device to improve sealability of a sub-shutter device, (b) opening a main passage space between the door frame and a guide rail by using a main shutter device, (c) closing the main passage space between the door frame and the guide rail by using the main shutter device when a fire breaks out, and (d) closing an internal space of the guide rail by using the sub-shutter device associated with the main shutter device, when the main shutter device is closed.

Step (d) may include (d-1) pressing, by another sub-shutter device, a push bar to slide backward in a first direction, when the main shutter device is closed, (d-2) converting, by an inclined link hinge-coupled to the push bar, first-direction motion into second-direction motion, and (d-3) sliding and stretching out, by the inclined link, an expandable wing in a second direction from a storage space of a housing.

According to another aspect of the present invention, there is provided a fire protection apparatus including a door frame mounted in a vertical passage between an upper floor and a lower floor of a building or in a horizontal passage between a first compartment and a second compartment of the building, a guide rail provided at a side of the door frame to guide a lift to pass through the vertical passage or to guide a carriage to pass through the horizontal passage, a main shutter device mounted on the door frame to open or close a main passage space between the door frame and the guide rail, a sub-shutter device mounted on the main shutter device to close an internal space of the guide rail in association with the main shutter device when the main shutter device is closed, and a position adjusting device mounted between an installation surface of the building and the door frame to improve sealability of the sub-shutter device, and adjusting a position of the door frame, wherein the position adjusting device includes a base mounted on the installation surface of the building, a screw rod mounted on the base, and a nut member screw-coupled to the screw rod to move forward or backward so as to support the door frame, wherein the guide rail is provided, at a side, with a hollow part through which the sub-shutter device passes and which has a sufficient height greater than a maximum height of the sub-shutter device adjustable by the position adjusting device, wherein the sub-shutter device includes a housing fixed to the main shutter device and having a storage space, a push bar protruding from the housing and mounted on the housing to slide in a first direction, an expandable wing mounted in the storage space of the housing to slide in a second direction so as to be stretched out or retracted in, a power transmitter for converting first-direction motion into second-direction motion to stretch out the expandable wing in the second direction when the push bar is pressed in the first direction, and an elastic spring for applying elastic restoring force in a forward direction of the push bar, wherein the power transmitter includes an inclined link having an end hinge-coupled to a bar hinge shaft provided at a side of the push bar, and another end hinge-coupled to a wing hinge shaft provided at a rear end of the expandable wing and penetrating through a guide hole formed in the housing along the second direction, wherein the housing is provided in a shape corresponding to the hollow part formed in the guide rail such that at least a portion of the housing penetrates through the hollow part to stretch out the expandable wing, wherein the main shutter device includes a first main shutter mounted at a side of a main shutter guide member mounted on the door frame, and moved along the main shutter guide member, a second main shutter mounted at another side of the main shutter guide member mounted on the door frame, and moved along the main shutter guide member, and a shutter driver for driving the first and second main shutters toward or away from each other by using a single motor, wherein the sub-shutter device includes a first sub-shutter mounted at a front end of the first main shutter, and a second sub-shutter mounted at a front end of the second main shutter to correspond to the first sub-shutter, and wherein the guide rail includes a first rail for guiding a side of the lift or the carriage, and a second rail for guiding another side of the lift or the carriage.

### BRIEF DESCRIPTION OF THE DRAWINGS

The above and other features and advantages of the present invention will become more apparent by describing in detail embodiments thereof with reference to the attached drawings in which:

FIG. 1 is a perspective view of a fire protection apparatus according to some embodiments of the present invention;

FIG. 2 is a side view of the fire protection apparatus of FIG. 1;

FIG. 3 is a cross-sectional view of a position adjusting device of the fire protection apparatus of FIG. 2;

FIG. 4 is a plan view (or front view) showing a shutter open state of the fire protection apparatus of FIG. 1;

FIG. 5 is a plan view (or front view) showing a shutter closed state of the fire protection apparatus of FIG. 4;

FIGS. 6 to 8 are plan views showing operation of a sub-shutter device of the fire protection apparatus of FIG. 4 step by step;

FIG. 9 is a perspective view of the sub-shutter device of the fire protection apparatus of FIG. 4;

FIGS. 10 to 12 are perspective views showing operation of the sub-shutter device of the fire protection apparatus of FIG. 4 step by step;

FIG. 13 is a flowchart of a fire protection method according to some embodiments of the present invention; and

FIG. 14 is a detailed flowchart of step (d) of the fire protection method of FIG. 13.

### DETAILED DESCRIPTION OF THE INVENTION

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses or sizes of layers are exaggerated for clarity and convenience of explanation.

The terminology used herein is for the purpose of describing particular embodiments and is not intended to limit the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, components, and/or groups thereof, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, the embodiments of the invention should not be construed as limited to the particular shapes of regions illustrated herein, but are to include deviations in shapes that result, for example, from manufacturing.

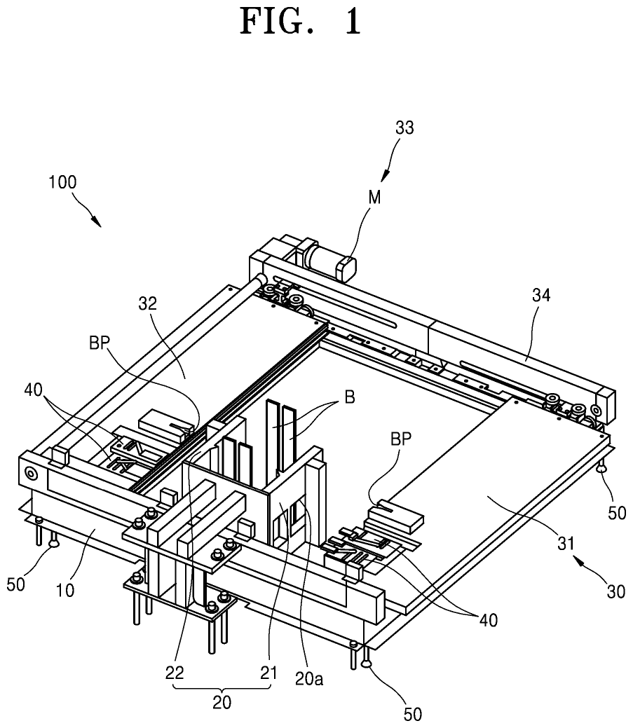

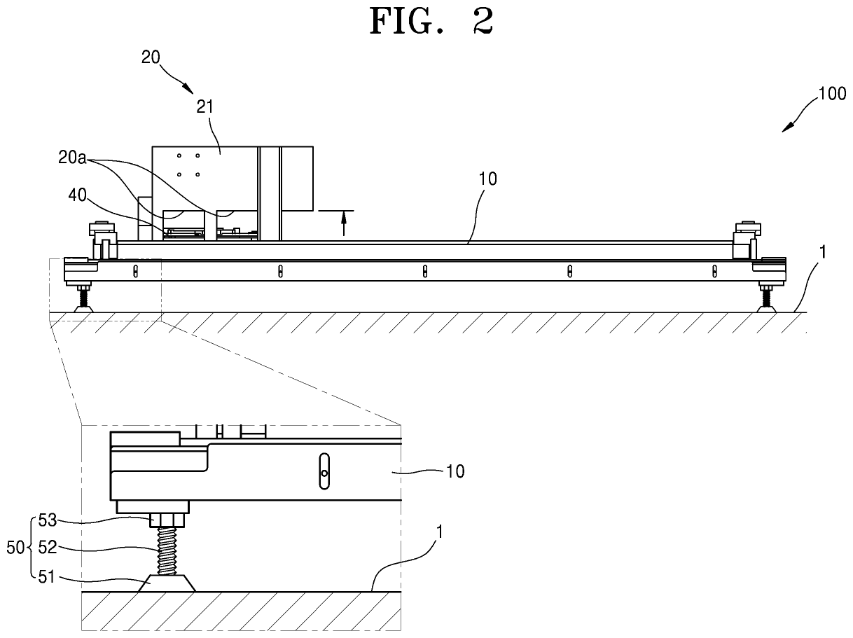

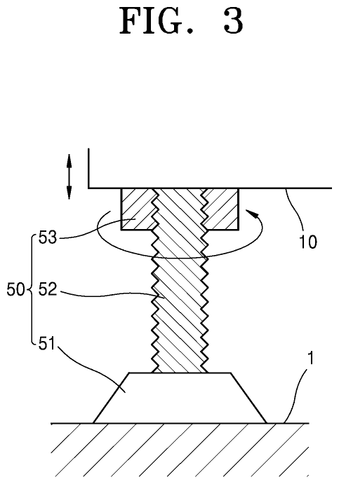

FIG. 1 is a perspective view of a fire protection apparatus 100 according to some embodiments of the present invention, FIG. 2 is a side view of the fire protection apparatus 100 of FIG. 1, and FIG. 3 is a cross-sectional view of a position adjusting device 50 of the fire protection apparatus 100 of FIG. 2.

As shown in FIGS. 1 to 3, the fire protection apparatus 100 according to some embodiments of the present invention may include a door frame 10, a guide rail 20, a main shutter device 30, and a sub-shutter device 40.

The position adjusting device 50 is mounted between an installation surface 1 of a building and the door frame 10 to improve sealability of the sub-shutter device 40 by adjusting a mounting height of the sub-shutter device 40 on the basis of fixed rails or stators of a linear motor (not shown) when the fixed rails or stators of the linear motor are mounted in the guide rail 20, and may be a device for adjusting a position of the door frame 10 by adjusting a gap between the installation surface 1 and the door frame 10.

As shown in FIGS. 2 and 3, a total of four position adjusting devices 50 may be mounted, one at each of four corners of a lower surface of the door frame 10. Specifically, for example, the position adjusting device 50 may include a base 51 mounted on the installation surface 1 of the building, a screw rod 52 mounted on the base 51, and a nut member 53 screw-coupled to the screw rod 52 to move forward or backward so as to adjust a height of the door frame 10 by supporting the door frame 10.

The guide rail 20 may be provided, at a side, with a hollow part 20a through which the sub-shutter device 40 passes and which has a sufficient height h greater than a maximum height of the sub-shutter device 40 adjustable by the position adjusting device 50.

Therefore, a user may adjust the sub-shutter device 40 to the height of the fixed rails or stators of the linear motor by rotating a total of four nut members 53, one mounted at each of the four corners of the lower surface of the door frame 10, with a wrench, spanner, socket, jig, or the like, thereby greatly improving smoke sealability.

Accordingly, sealability of the sub-shutter device 40 may be greatly improved by accurately positioning the sub-shutter device 40 between the rails or stators of the linear motor by using the position adjusting device 50 when the linear motor is mounted in the guide rail 20.

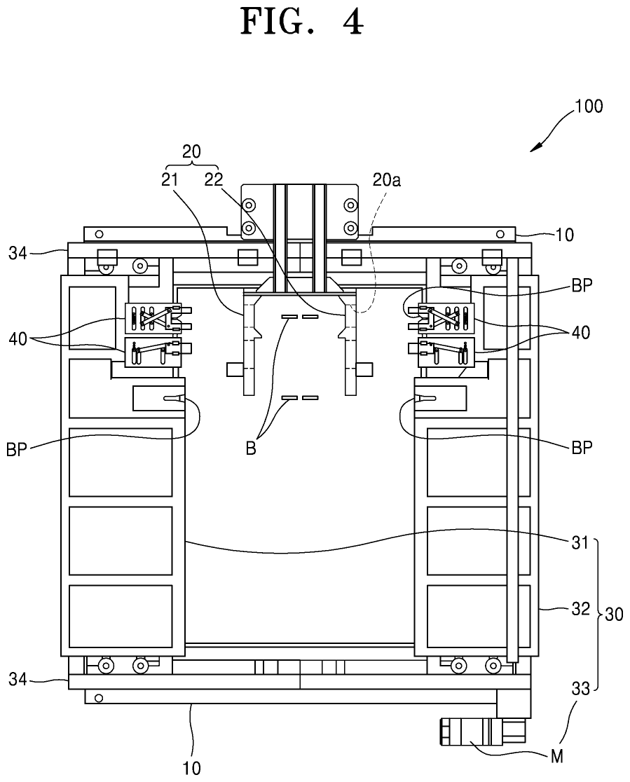

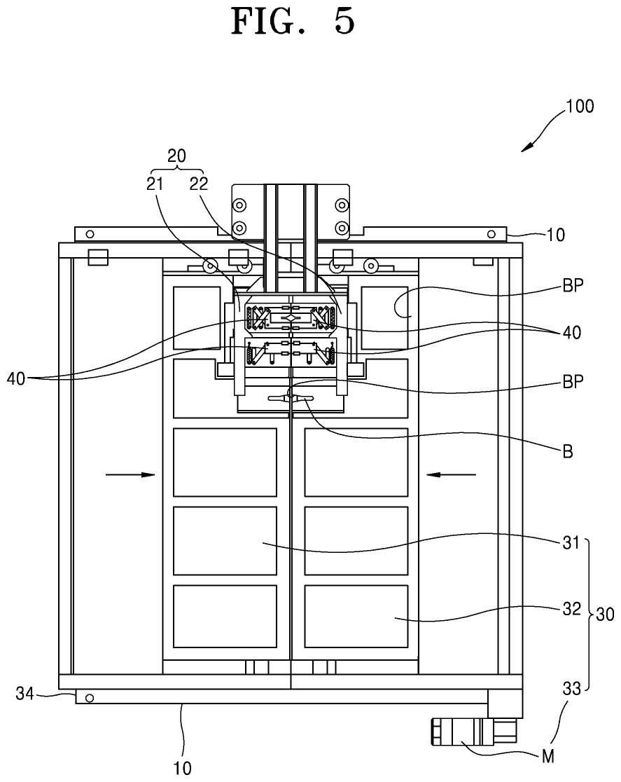

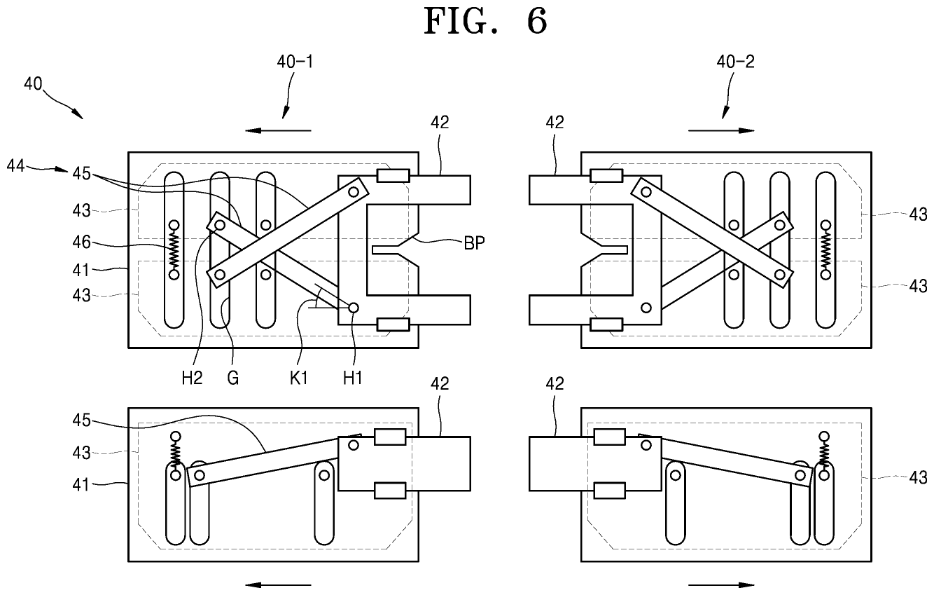

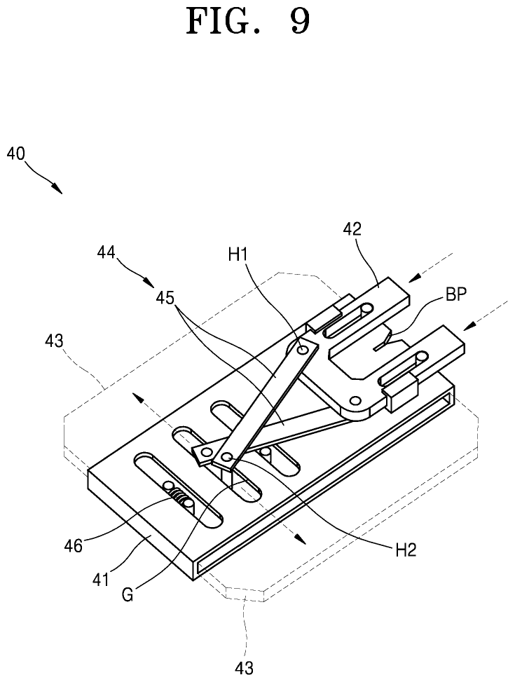

FIG. 4 is a plan view (or front view) showing a shutter open state of the fire protection apparatus 100 of FIG. 1, FIG. 5 is a plan view (or front view) showing a shutter closed state of the fire protection apparatus 100 of FIG. 4, FIGS. 6 to 8 are plan views showing operation of the sub-shutter device 40 of the fire protection apparatus 100 of FIG. 4 step by step, and FIG. 9 is a perspective view of the sub-shutter device 40 of the fire protection apparatus 100 of FIG. 4.

The door frame 10 may be a sort of rectangular doorframe structure mounted in a vertical passage between an upper floor and a lower floor of the building or in a horizontal passage between a first compartment and a second compartment of the building.

The guide rail 20 may be a sort of guide member provided at a side of the door frame 10 to guide a lift (not shown) to pass through the vertical passage or to guide a carriage (not shown) to pass through the horizontal passage.

The guide rail 20 may include a first rail 21 for guiding a side of the lift or the carriage, and a second rail 22 for guiding another side of the lift or the carriage.

The first and second rails 21 and 22 may be provided in symmetrical shapes to face each other. Although the first and second rails 21 and 22 linearly extend in a vertical direction to guide the lift upward or downward in the drawings, a wide variety of rails such as inclined or curved rails are also applicable so as to be mounted in various environments.

Herein, each of the first and second rails 21 and 22 may be provided, at a side, with the hollow part 20a through which at least a portion of the sub-shutter device 40 passes.

As shown in FIGS. 4 and 5, the main shutter device 30 may include a relatively large main shutter structure mounted on the door frame 10 to open or close a main passage space between the door frame 10 and the guide rail 20.

The main shutter device 30 may include a first main shutter 31 mounted at a side of a main shutter guide member 34 mounted on the door frame 10, and moved along the main shutter guide member 34, a second main shutter 32 mounted at another side of the main shutter guide member 34 mounted on the door frame 10, and moved along the main shutter guide member 34, and a shutter driver 33 for driving the first and second main shutters 31 and 32 toward or away from each other by using a single motor M.

Conveyor belt protection slits BP may be formed at front ends of the first and second main shutters 31 and 32 to protect conveyor belts B.

As shown in FIGS. 6 to 9, the sub-shutter device 40 may be a sort of expandable wing structure mounted on the main shutter device 30 to close an internal space of the guide rail 20 in association with the main shutter device 30 when the main shutter device 30 is closed.

The sub-shutter device 40 may include a housing 41 fixed to the main shutter device 30 and having a storage space, a push bar 42 protruding from the housing 41 and mounted on the housing 41 to slide in a first direction, an expandable wing 43 mounted in the storage space of the housing 41 to slide in a second direction so as to be stretched out or retracted in, a power transmitter 44 for converting first-direction motion into second-direction motion to stretch out the expandable wing 43 in the second direction when the push bar 42 is pressed in the first direction, and an elastic spring 46 for applying elastic restoring force in a forward direction of the push bar 42.

The housing 41 may be provided in a shape corresponding to the hollow part 20a formed in the guide rail 20 such that at least a portion thereof may penetrate through the hollow part 20a to stretch out the expandable wing 43.

The power transmitter 44 may include an inclined link 45 having an end hinge-coupled to a bar hinge shaft H1 provided at a side of the push bar 42, and another end hinge-coupled to a wing hinge shaft H2 provided at a rear end of the expandable wing 43 and penetrating through a guide hole G formed in the housing 41 along the second direction.

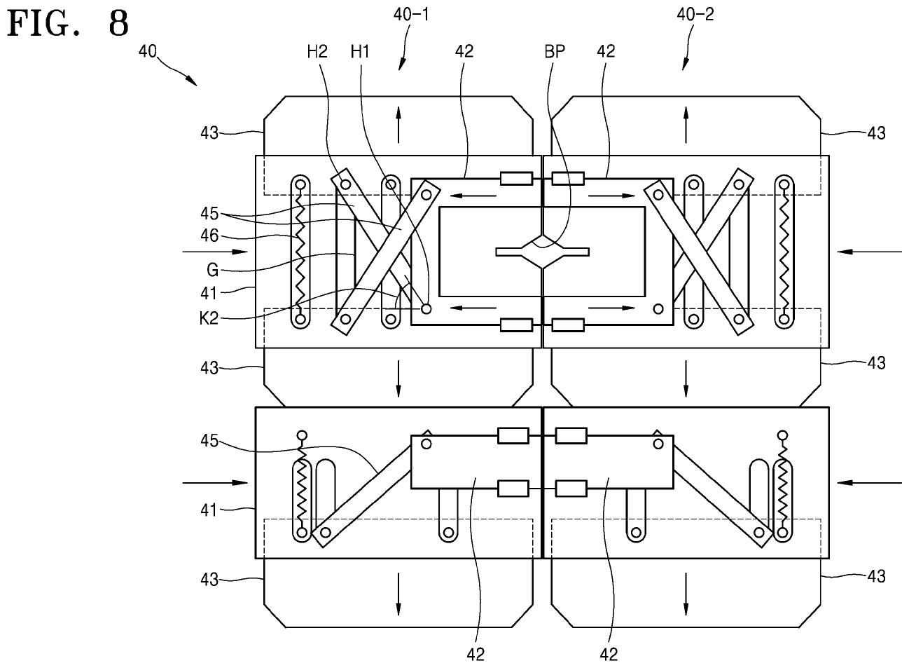

The inclined link 45 may be inclined at a first angle K1 of FIG. 6 with respect to the first direction when the expandable wing 43 is retracted in, or inclined at a second angle K2 of FIG. 8, which is greater than the first angle K1, with respect to the first direction when the expandable wing 43 is stretched out.

The inclined link 45 may include two links, which cross each other in an X shape overall, to simultaneously stretch out a side expandable wing 43 and another side expandable wing 43.

Herein, the push bar 42 connected to the two links may be provided in a U shape overall.

Alternatively, as shown in FIGS. 6 to 8, the push bar 42 may be provided in a linear shape, and the inclined link 45 of a linear shape may be inclined with respect to the push bar 42.

Meanwhile, the sub-shutter device 40 may include a first sub-shutter 40-1 mounted at a front end of the first main shutter 31, and a second sub-shutter 40-2 mounted at a front end of the second main shutter 32 to correspond to the first sub-shutter 40-1, and the push bars 42 of the first and second sub-shutters 40-1 and 40-2 may be mounted at corresponding positions and pressed in contact with each other to stretch out the expandable wings 43 of the first and second sub-shutters 40-1 and 40-2 in association with the first and second main shutters 31 and 32 when the first and second main shutters 31 and 32 are closed.

Conveyor belt protection slits BP may be formed at front ends of the first and second sub-shutters 40-1 and 40-2 to protect conveyor belts B.

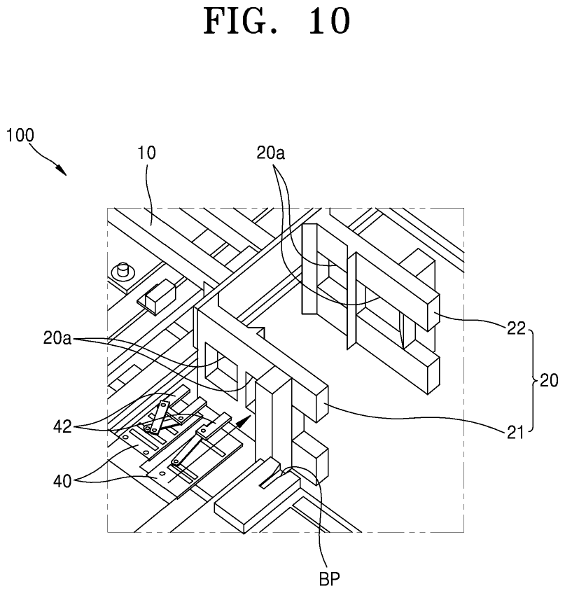

FIGS. 10 to 12 are perspective views showing operation of the sub-shutter device 40 of the fire protection apparatus 100 of FIG. 4 step by step.

As shown in FIGS. 6 and 10, before a fire breaks out, the main passage space between the door frame 10 and the guide rail 20 may be opened using the main shutter device 30.

In this case, when the main shutter device 30 is opened, the expandable wing 43 of the sub-shutter device 40 may be retracted into the storage space of the housing 41 to stand by.

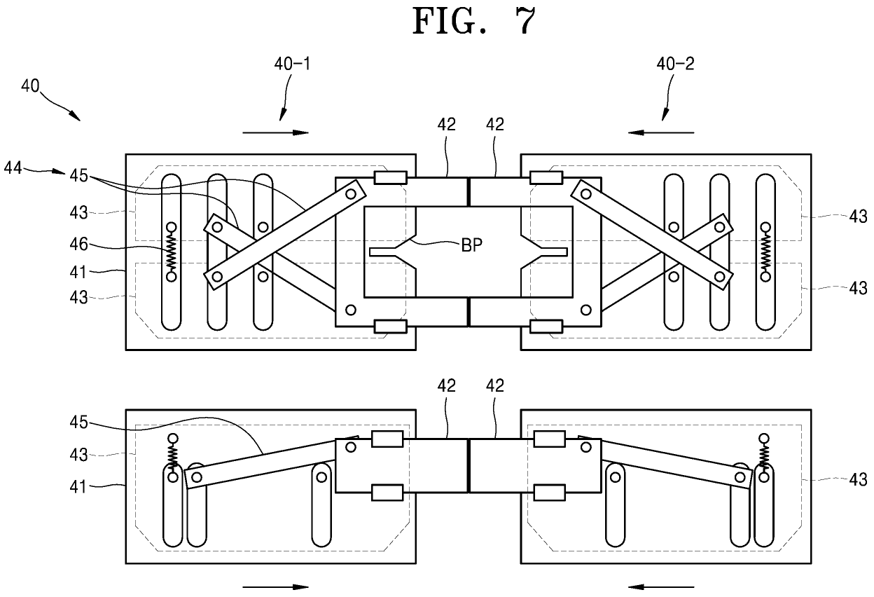

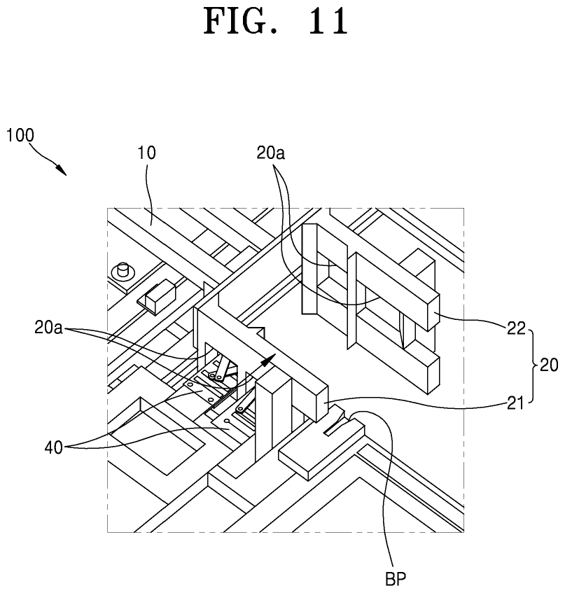

Then, as shown in FIGS. 7 and 11, when a fire breaks out, the main shutter device 30 may be driven to the main passage space between the door frame 10 and the guide rail 20 by using the single motor M of the main shutter device 30.

In this case, at least a portion of the sub-shutter device 40 may penetrate through the hollow part 20a of the guide rail 20 and enter the internal space of the guide rail 20.

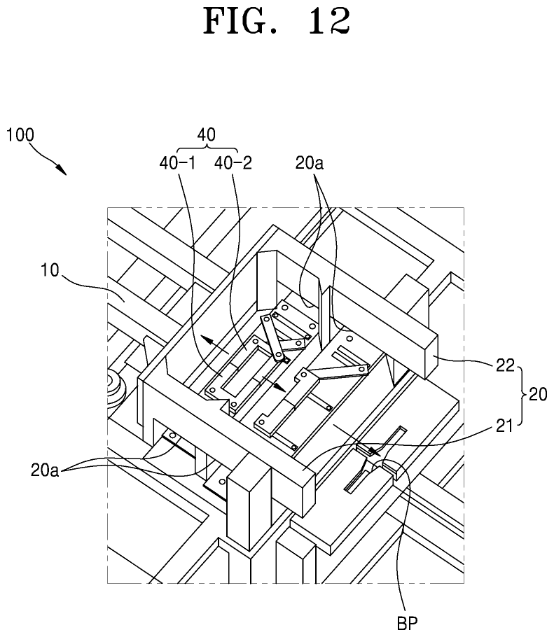

Then, as shown in FIGS. 8 and 12, when the main shutter device 30 is completely closed, the internal space of the guide rail 20 may be closed using the sub-shutter device 40 associated with the main shutter device 30.

In this case, when the main shutter device 30 is closed, the push bar 42 may be pressed by another sub-shutter device 40 to slide backward in the first direction, the inclined link 45 hinge-coupled to the push bar 42 may convert first-direction motion into second-direction motion, and the expandable wing 43 may be slid and stretched out in the second direction from the storage space of the housing 41 by the inclined link 45 to close the internal space of the guide rail 20.

Accordingly, by associating the main shutter device 30 with the sub-shutter device 40, structural simplification and product cost reduction may be achieved, and apparatus operation and management may be facilitated. As such, space utilization and apparatus reliability may be greatly increased using the single motor M, and cost reduction may be achieved by omitting motors, sensors, complicated link structures, separate controllers, etc. used for an existing sub-shutter.

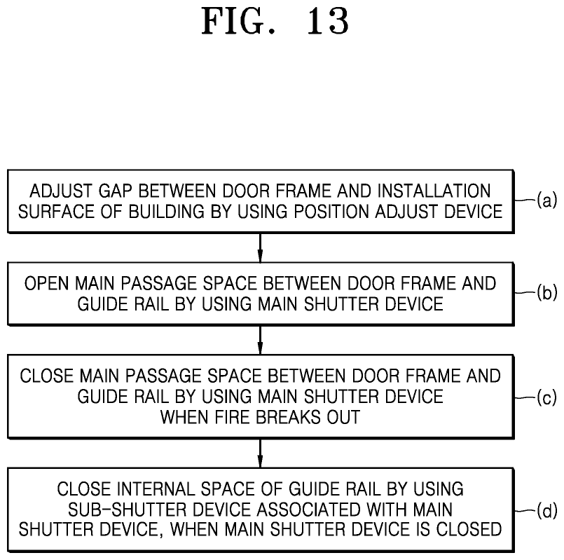

FIG. 13 is a flowchart of a fire protection method according to some embodiments of the present invention.

As shown in FIGS. 1 to 13, the fire protection method according to some embodiments of the present invention may include (a) adjusting a gap between the door frame 10 and the installation surface 1 of a building by using the position adjusting device 50 to improve sealability of the sub-shutter device 40, (b) opening a main passage space between the door frame 10 and the guide rail 20 by using the main shutter device 30, (c) closing the main passage space between the door frame 10 and the guide rail 20 by using the main shutter device 30 when a fire breaks out, and (d) closing an internal space of the guide rail 20 by using the sub-shutter device 40 associated with the main shutter device 30, when the main shutter device 30 is closed.

In step (b), the expandable wing 43 of the sub-shutter device 40 may be retracted into a storage space of the housing 41.

In step (c), at least a portion of the sub-shutter device 40 may penetrate through the hollow part 20a of the guide rail 20.

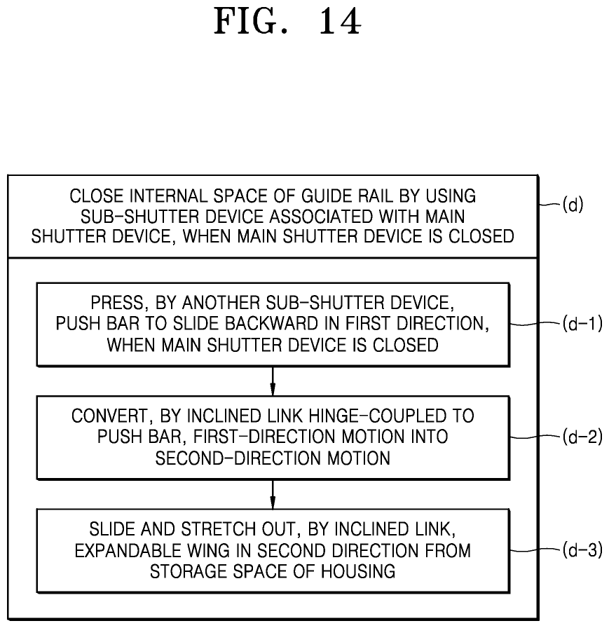

FIG. 14 is a detailed flowchart of step (d) of the fire protection method of FIG. 13.

Step (d) may include (d-1) pressing, by another sub-shutter device 40, the push bar 42 to slide backward in the first direction, when the main shutter device 30 is closed, (d-2) converting, by the inclined link 45 hinge-coupled to the push bar 42, first-direction motion into second-direction motion, and (d-3) sliding and stretching out, by the inclined link 45, the expandable wing 43 in the second direction from the storage space of the housing 41.

According to the afore-described embodiments of the present invention, sealability of a sub-shutter device may be greatly improved by accurately positioning the sub-shutter device between rails or stators of a linear motor by using a position adjusting device when the linear motor is mounted in a guide rail, structural simplification and product cost reduction may be achieved by associating a main shutter device with the sub-shutter device, apparatus operation and management may be facilitated, space utilization and apparatus reliability may be greatly increased using a single motor, and cost reduction may be achieved by omitting motors, sensors, complicated link structures, separate controllers, etc. used for existing sub-shutters. However, the scope of the present invention is not limited to the above effects.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. A fire protection apparatus comprising:
a door frame mounted in a vertical passage between an upper floor and a lower floor of a building or in a horizontal passage between a first compartment and a second compartment of the building;
a guide rail provided at a side of the door frame to guide a lift to pass through the vertical passage or to guide a carriage to pass through the horizontal passage;
a main shutter device mounted on the door frame to open or close a main passage space between the door frame and the guide rail;
a sub-shutter device mounted on the main shutter device to close an internal space of the guide rail in association with the main shutter device when the main shutter device is closed; and
a position adjusting device mounted between an installation surface of the building and the door frame to improve sealability of the sub-shutter device, and adjusting a position of the door frame.

2. The fire protection apparatus of claim 1, wherein the position adjusting device comprises:
a base mounted on the installation surface of the building;
a screw rod mounted on the base; and
a nut member screw-coupled to the screw rod to move forward or backward so as to support the door frame.

3. The fire protection apparatus of claim 1, wherein the guide rail is provided, at a side, with a hollow part through which the sub-shutter device passes and which has a sufficient height greater than a maximum height of the sub-shutter device adjustable by the position adjusting device.

4. The fire protection apparatus of claim 1, wherein the sub-shutter device comprises:
a housing fixed to the main shutter device and having a storage space;
a push bar protruding from the housing and mounted on the housing to slide in a first direction;
an expandable wing mounted in the storage space of the housing to slide in a second direction so as to be stretched out or retracted in; and
a power transmitter for converting first-direction motion into second-direction motion to stretch out the expandable wing in the second direction when the push bar is pressed in the first direction.

5. The fire protection apparatus of claim 4, wherein the power transmitter comprises an inclined link having an end hinge-coupled to a bar hinge shaft provided at a side of the push bar, and another end hinge-coupled to a wing hinge shaft provided at a rear end of the expandable wing and penetrating through a guide hole formed in the housing along the second direction.

6. The fire protection apparatus of claim 5, wherein the inclined link is inclined at a first angle with respect to the first direction when the expandable wing is retracted in, or inclined at a second angle, which is greater than the first angle, with respect to the first direction when the expandable wing is stretched out.

7. The fire protection apparatus of claim 5, wherein the inclined link comprises two links, which cross each other in an X shape overall, to simultaneously stretch out a side expandable wing and another side expandable wing.

8. The fire protection apparatus of claim 7, wherein the push bar connected to the two links is provided in a U shape overall.

9. The fire protection apparatus of claim 4, wherein the sub-shutter device further comprises an elastic spring for applying elastic restoring force in a forward direction of the push bar.

10. The fire protection apparatus of claim 4, wherein the housing is provided in a shape corresponding to the hollow part formed in the guide rail such that at least a portion of the housing penetrates through the hollow part to stretch out the expandable wing.

11. The fire protection apparatus of claim 1, wherein the main shutter device comprises:
a first main shutter mounted at a side of a main shutter guide member mounted on the door frame, and moved along the main shutter guide member;
a second main shutter mounted at another side of the main shutter guide member mounted on the door frame, and moved along the main shutter guide member; and
a shutter driver for driving the first and second main shutters toward or away from each other by using a single motor.

12. The fire protection apparatus of claim 11, wherein conveyor belt protection slits are formed at front ends of the first and second main shutters to protect conveyor belts.

13. The fire protection apparatus of claim 11, wherein the sub-shutter device comprises:
a first sub-shutter mounted at a front end of the first main shutter; and
a second sub-shutter mounted at a front end of the second main shutter to correspond to the first sub-shutter.

14. The fire protection apparatus of claim 13, wherein push bars of the first and second sub-shutters are mounted at corresponding positions and pressed in contact with each other to stretch out expandable wings of the first and second sub-shutters in association with the first and second main shutters when the first and second main shutters are closed.

15. The fire protection apparatus of claim 13, wherein conveyor belt protection slits are formed at front ends of the first and second sub-shutters to protect conveyor belts.

16. The fire protection apparatus of claim 1, wherein the guide rail comprises:
a first rail for guiding a side of the lift or the carriage; and
a second rail for guiding another side of the lift or the carriage.

17. The fire protection apparatus of claim 16, wherein the first or second rail is provided, at a side, with a hollow part through which at least a portion of the sub-shutter device passes.

18. A fire protection method comprising:
(a) adjusting a gap between a door frame and an installation surface of a building by using a position adjusting device to improve sealability of a sub-shutter device;
(b) opening a main passage space between the door frame and a guide rail by using a main shutter device;
(c) closing the main passage space between the door frame and the guide rail by using the main shutter device when a fire breaks out; and
(d) closing an internal space of the guide rail by using the sub-shutter device associated with the main shutter device, when the main shutter device is closed.

19. The fire protection method of claim 16, wherein step (d) comprises:
(d-1) pressing, by another sub-shutter device, a push bar to slide backward in a first direction, when the main shutter device is closed;
(d-2) converting, by an inclined link hinge-coupled to the push bar, first-direction motion into second-direction motion; and
(d-3) sliding and stretching out, by the inclined link, an expandable wing in a second direction from a storage space of a housing.

20. A fire protection apparatus comprising:
a door frame mounted in a vertical passage between an upper floor and a lower floor of a building or in a horizontal passage between a first compartment and a second compartment of the building;
a guide rail provided at a side of the door frame to guide a lift to pass through the vertical passage or to guide a carriage to pass through the horizontal passage;
a main shutter device mounted on the door frame to open or close a main passage space between the door frame and the guide rail;
a sub-shutter device mounted on the main shutter device to close an internal space of the guide rail in association with the main shutter device when the main shutter device is closed; and
a position adjusting device mounted between an installation surface of the building and the door frame to improve sealability of the sub-shutter device, and adjusting a position of the door frame,
wherein the position adjusting device comprises:
a base mounted on the installation surface of the building;
a screw rod mounted on the base; and
a nut member screw-coupled to the screw rod to move forward or backward so as to support the door frame,
wherein the guide rail is provided, at a side, with a hollow part through which the sub-shutter device passes and which has a sufficient height greater than a maximum height of the sub-shutter device adjustable by the position adjusting device,
wherein the sub-shutter device comprises:
a housing fixed to the main shutter device and having a storage space;
a push bar protruding from the housing and mounted on the housing to slide in a first direction;
an expandable wing mounted in the storage space of the housing to slide in a second direction so as to be stretched out or retracted in;
a power transmitter for converting first-direction motion into second-direction motion to stretch out the expandable wing in the second direction when the push bar is pressed in the first direction; and
an elastic spring for applying elastic restoring force in a forward direction of the push bar,
wherein the power transmitter comprises an inclined link having an end hinge-coupled to a bar hinge shaft provided at a side of the push bar, and another end hinge-coupled to a wing hinge shaft provided at a rear end of the expandable wing and penetrating through a guide hole formed in the housing along the second direction,
wherein the housing is provided in a shape corresponding to the hollow part formed in the guide rail such that at least a portion of the housing penetrates through the hollow part to stretch out the expandable wing,
wherein the main shutter device comprises:
a first main shutter mounted at a side of a main shutter guide member mounted on the door frame, and moved along the main shutter guide member;
a second main shutter mounted at another side of the main shutter guide member mounted on the door frame, and moved along the main shutter guide member; and
a shutter driver for driving the first and second main shutters toward or away from each other by using a single motor,
wherein the sub-shutter device comprises:
a first sub-shutter mounted at a front end of the first main shutter; and
a second sub-shutter mounted at a front end of the second main shutter to correspond to the first sub-shutter, and
wherein the guide rail comprises:
a first rail for guiding a side of the lift or the carriage; and
a second rail for guiding another side of the lift or the carriage.
